(19) United States
(12) Patent Application Publication
(10) Pub. No.: US 2009/0194545 A1
(43) Pub. Date: Aug. 6, 2009

(54) HIGH-PRESSURE HYDROGEN CONTAINER

(76) Inventors: Itsuo Kamiya, Aichi (JP); Rentaro Mori, Aichi (JP); Masashi Kudo, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/438,760

(22) PCT Filed: Aug. 31, 2007
(86) PCT No.: PCT/JP2007/067457

§ 371 Date: Feb. 25, 2009

(51) Int. Cl. F17C 1/02; F17C 1/16

(52) U.S. Cl. 220/586

(57) ABSTRACT

According to the present invention, a high-pressure hydrogen container that is filled with hydrogen at high pressures, in which at least one elastomer is used as a sealing material, such elastomer having a hydrogen gas permeability coefficient or helium gas permeability coefficient of 5.0×10⁻¹⁰ to 5.0×10⁻⁹ cm³ (STP)·cm/cm²·sec·cmHg, is provided. The following main technical objectives for realizing sealing with an elastomer material for a high-pressure hydrogen container (CHG tank) system for fuel-cell vehicles are achieved: (1) good durability in variable pressure environments of high-pressure hydrogen is imparted to such elastomer material; and (2) good anti-permanent deformation properties in low-temperature and high-temperature environments are imparted to such elastomer material.

### TECHNICAL FIELD

The present invention relates to a high-pressure hydrogen container that is a highly suitable vehicular container for supplying hydrogen to fuel cells. In particular, the present invention relates to a sealing material that has good durability in variable pressure environments of high-pressure hydrogen.

### BACKGROUND ART

In recent years, gas tanks (gas cylinders) that store hydrogen or natural gas serving as fuel for electric power generation have been used in automobiles, houses, transport machinery, and the like.

For instance, polymer electrolyte fuel cells have been gaining attention as a power source for automobiles. When such fuel cells are used for electric power generation, an electrochemical reaction is induced by supplying a gas fuel (e.g., hydrogen gas) to a gas diffusion electrode layer provided on one side of each fuel cell and supplying an oxidant gas (e.g., air containing oxygen) to a gas diffusion electrode layer provided on the other side. Upon such electric power generation, nontoxic water is exclusively produced. Thus, the above fuel cells have been gaining attention from viewpoints of environmental influences and use efficiency.

In order to continuously supply a gas fuel such as hydrogen gas to an automobile equipped with the above fuel cells, a gas fuel is stored in an in-vehicle gas tank. Examples of in-vehicle hydrogen gas tanks that have been examined include a gas tank that stores compressed hydrogen and a hydrogen-storing gas tank that stores hydrogen in a state of absorption in metal hydride (MH).

Among them, a CFRP (carbon fiber-reinforced plastic) tank has been examined for use as an in-vehicle gas tank that stores compressed hydrogen. A CFRP tank is structured such that a liner layer (inner shell) that maintains airtight properties of the tank is formed inside a layer (outer shell: fiber-reinforced layer) comprising a carbon fiber-reinforced plastic (CFRP material). Such CFRP tank has strength greater than that of a tank made of a usual type of plastic and is excellent in pressure resistance, and therefore it is preferably used as a gas fuel tank.

As an aside, a high-pressure hydrogen container (compressed hydrogen gas tank: CHG tank) system in a fuel-cell vehicle is filled with high-pressure hydrogen gas (between 35 MPa and 75 MPa). In such case, in terms of the degree of freedom of sealing material design, sealing with the use of elastomer material is more desirable than sealing with the use of metal material. In addition, the development of material that has durability against filling and discharge of a high-pressure hydrogen gas at high frequency is awaited. Hydrogen gas incorporated into an elastomer at high pressures tends to diffuse outside the elastomer under reduced pressure so that it is necessary for such material to be durable in variable pressure environments. Further, it is necessary for such material to be durable in variable temperature environments (approximately between a low temperature of −70° C. and a high temperature of 80° C.).

There are a variety of known sealing materials that are generally used. For instance, the following Patent Document 1 discloses a rubber composition comprising a specific hydrogenated nitrile rubber (a) to which a specific carbon black (b) has been added, such carbon black having specific surface area, compressed DBP oil absorption amount, tint strength, ratio of specific surface area for nitrogen adsorption to iodine adsorption amount, and electron-microscopically-observed average particle size. This is because, when conventional materials obtained by adding silicon dioxide to hydrogenated nitrile rubber are used for molding of sealing members for car air-conditioner compressors, the sealing members obtained by vulcanization molding of such materials are not satisfactory in terms of fluorohydrocarbon-resistant properties (blister resistance) and wear resistance (necessary for movable sealing members) under high temperature conditions. The reference also describes that a product obtained by vulcanization molding of such rubber composition, which is used for sealing members and the like for car air-conditioner compressors, is excellent in blister resistance, wear resistance, and the like.

In addition, in the following Non-Patent Document 1, a liquid elastomer was theoretically analyzed in terms of absorption, high-pressure permeation, and rapid disintegration (explosive disintegration), with the title of “Durability of TFE/P and other fluoroelastomers when used in stringent high-pressure environments for sealing purposes.” The obtained results were further confirmed by experimentation. The reference also describes that sealing materials tend to deteriorate due to physical influences rather than chemical reactions. In addition, the reference introduces, as a fluoroelastomer, an elastomer (explosion-proof elastomer) that is excellent in terms of durability against rapid disintegration (explosive disintegration).

However, an explosion-proof elastomer is significantly inferior in “permanent deformation performance,” which is important for sealing duration performance, and in “low-temperature properties (elastic recovery properties),” which are important in an environment in which a high-pressure hydrogen tank for fuel cells is used. These issues have been problematic.

It is considered that the above problems have occurred for following reasons.

(1) The crosslink density of a fluoroelastomer is excessively increased; that is to say, an elastomer material is formed into an ebonite material in a manner such that the material is modified in order to improve explosion-proof properties of an explosion-proof elastomer. This results in loss of elastic recovery properties essentially imparted to an elastomer material.
(2) The amount of gas absorption in an elastomer is suppressed in order to improve explosion-proof properties. Specifically, the composition of an elastomer is modified such that the polymer fraction is lowered (the polymer fraction is lowered in a mixed composition). Such modification is considered to result in impairment of elastomer characteristics, leading to deterioration in anti-permanent deformation properties.
(3) A fluoroelastomer is essentially inferior in low-temperature properties. In addition, low-temperature properties deteriorate as a result of the modifications described in (1) and (2) above.

### Patent Document 1: JP Patent Publication (Kokai) No. 10-182882 A (1998)

### Non-Patent Document 1: Plast Rubber Compos Process Appl JIN: D0988B ISSN: 0959-8111 VOL. 22, No. 3

### DISCLOSURE OF THE INVENTION

As described above, for a high-pressure hydrogen container (CHG tank) system for fuel-cell vehicles, sealing with the use of elastomer material is desired in view of degree of freedom of sealing material design. However, an explosion-proof fluoroelastomer, which is a conventional elastomer sealing material, is problematic in terms of the large increase in “permanent deformation amount (compression set)” of such elastomer caused by repetition of filling and discharge of high-pressure hydrogen, in addition to changes in appearance due to expansion, foaming, and the like.

That is to say, the main technical objectives for realizing sealing with an elastomer material for a high-pressure hydrogen container (CHG tank) system for fuel-cell vehicles are as follows: (1) good durability in variable pressure environments of high-pressure hydrogen is imparted to such elastomer material; and (2) good anti-permanent deformation properties in low-temperature and high-temperature environments are imparted to such elastomer material. Thus, it is an objective of the present invention to provide an elastomer material that is excellent in terms of both technical objectives described above.

The present inventors have found that the above problems can be solved by using an elastomer having high hydrogen gas diffusivity as a sealing material for high-pressure hydrogen containers. Accordingly, they have arrived at the present invention.

Specifically, in a first aspect, the present invention relates to a high-pressure hydrogen container that is filled with hydrogen at high pressures. Such container is characterized in that at least one elastomer is used as a sealing material, such elastomer having a hydrogen gas permeability coefficient or helium gas permeability coefficient of 5.0×10⁻¹⁰ to 5.0×10⁻⁹ cm³ (STP)·cm/cm²·sec·cmHg. In addition, the sealing material should be originally specified based on the hydrogen gas permeability coefficient. However, for safety reasons, according to the present invention, it is also specified based on the helium gas permeability coefficient, since helium gas exhibits behavior similar to that of hydrogen gas. With the use of a sealing material having a helium gas permeability coefficient (hydrogen gas permeability coefficient) higher than that of a conventional sealing material, it becomes possible to prevent/reduce elastomer breakage due to the expansion/foaming stress of hydrogen gas absorbed in an elastomer upon rapid depressurization of high-pressure hydrogen.

Preferably, a sealing material for the high-pressure hydrogen container of the present invention has high strength. The hardness of the above elastomer is preferably from 75 IRHD to 95 IRHD. The hardness is obtained by a micro hardness test according to JIS K6253 with the use of an O ring specified in JIS B2401 G25. As a means of improving strength proof stress against expansion/foaming stress, sealing with an elastomer with a composition that results in high strength (high hardness) is carried out without impairment of the permanent deformation properties of such elastomer. In terms of hardness, the elastomer of the present invention is an elastomer having strength (high hardness) greater than that of a sealing elastomer used for general component systems, excluding conventional high-pressure hydrogen containers.

Further, preferably, the sealing material of the high-pressure hydrogen container of the present invention has low-temperature elastic recovery properties. Also preferably, the TR10 of the aforementioned elastomer, which is measured by a low-temperature elastic recovery test according to JIS K6261, is −30° C. or less.

Likewise, preferably, the sealing material of the high-pressure hydrogen container of the present invention has low temperature elastic recovery properties. Also preferably, the “permanent deformation amount (compression set)” of the aforementioned elastomer represented by the following equation is 20% or less. Permanent deformation amount (%) (compression set)=(D1−D2)÷(D1×0.2)×100 (where D1 represents the initial wire diameter and D2 represents the wire diameter obtained after compression by 20%, exposure to 30-MPa hydrogen gas at 85° C. for 1 hour, rapid depressurization to atmospheric pressure in 3 minutes, and release of compression).

Elastomer type is not limited as long as the elastomer complies with requirements of the sealing material of the high-pressure hydrogen container of the present invention. At least one elastomer is mixed and used. Specific examples of the aforementioned elastomer include at least one selected from the group consisting of ethylene propylene diene monomer rubber (EPDM), ethylene propylene rubber (EPR), silicon rubber, natural rubber, isoprene rubber (IR), and nitrile isoprene rubber (NIR). Among them, the most preferable example is high-hardness ethylene propylene diene monomer rubber (EPDM).

In a second aspect, the present invention is characterized in that the aforementioned high-pressure hydrogen container is a vehicular high-pressure hydrogen container for supplying hydrogen to fuel cells in a fuel-cell vehicle.

The sealing material of the high-pressure hydrogen container of the present invention is a material that has: (1) duration performance in variable pressure environments of high-pressure hydrogen at a level equivalent to or exceeding that of an explosion-proof elastomer, which is a sealing material of the prior art; and (2) anti-permanent deformation properties in variable environments, including high-temperature and low-temperature environments, at a level much better than those of an explosion-proof elastomer of the prior art. The high-pressure hydrogen container of the present invention for which such sealing material is used is excellent in durability and is highly suitable in particular as a high-pressure hydrogen container for fuel-cell vehicles.

### BRIEF DESCRIPTION OF THE DRAWINGS

FIG. 1 schematically shows an evaluation test for “permanent deformation properties” with the use of a test piece (O ring).

FIG. 2 shows an example of contraction coefficient-temperature curve data.

### BEST MODE FOR CARRYING OUT THE INVENTION

### 1. Material Specifications and Basic Physical Properties in the Example and the Comparative Examples

A high-hardness EPDM that is suitable for the sealing material of the present invention is used for the Example. The hydrogen permeability coefficient of the high-hardness EPDM in this example is approximately 1×10⁻⁹ cm³ (STP)·cm/cm²·sec·cmHg. A PTFE perfluoro-type specialty elastomer (hereafter referred to as “explosion-proof elastomer 1”) that is conventionally used as an explosion-proof elastomer is used for Comparative example 1. In the same manner, a PTFE/propylene specialty elastomer (hereafter referred to as “explosion-proof elastomer 2”) is used for Comparative example 2.

In addition, the “explosion-proof elastomer 1” is Chemlok 526 (product name), which is a perfluoroelastomer in which all hydrogen atoms are substituted with fluorine atoms in a copolymer of three different monomers comprising, as a main component, ethylene tetrafluoride. Further, the “explosion-proof elastomer 2” is Chemlok 99 (product name), which is an elastomer obtained by modifying a copolymer of ethylene tetrafluoride and propylene and is excellent in chemical resistance so that it can be used in fluids having extreme properties in which fluororesin cannot be used.

The Example material and the Comparative example materials are compared in table 1 below in terms of elastomer specifications and basic physical properties. Herein, the measurement results of elastomer basic physical properties were obtained with the use of the following test piece by the following measurement method.

Test piece: An O ring specified in JIS B 2401 G25 was used as a test piece.
Physical properties: Hardness was measured with a micro rubber hardness meter.
Tensile strength at break: The strength was measured by a product physical property test according to JIS B 2401 9.1.1.

TABLE 1

| | | Elastomer basic | | |
|---|---|---|---|---|
| | | physical | | |
| | | properties | | |
| | | | Tensile | Approximate |
| | | | strength | helium gas |
| | | Hardness | at break | permeability |
| Classification/Material specification | | (IRHD) | (MPa) | coefficient |
| Example | High-hardness EPDM | 90 | 17.7 | 5 to 10 |
| material | | | | |
| Comparative | Explosion-proof | 95 | 16.8 | 1 |
| example 1 | elastomer 1 | | | |
| material | (PTFE perfluoro-type | | | |
| | specialty elastomer) | | | |
| Comparative | Explosion-proof | 90 | 13.6 | 1 to 3 |
| example 2 | elastomer 2 | | | |
| material | (PTFE/propylene | | | |
| | specialty elastomer) | | | |

### 2. High-Pressure Hydrogen Durability

Evaluation in terms of high-pressure hydrogen-resistant properties was carried out by an acceleration test in variable pressure environments. According to the method, an elastomer (the aforementioned O ring test piece) was exposed to a high-pressure hydrogen environment under predetermined conditions and then subjected to rapid depressurization to atmospheric pressure at a predetermined speed in a repetitive manner. The test procedures used herein are as follows.

(1) Test piece condition: The test piece is compressed by 20% with a compression board made of SUS and then subjected to the test.
(2) Hydrogen gas exposure conditions: The test piece is allowed to stand in 30-MPa hydrogen gas at 85° C. for 1 hour.
(3) Depressurization rate: Rapid depressurization is carried out at a rate at which depressurization release from 30 MPa to atmospheric pressure is completed in 3 minutes.
(4) Durability cycles: A cycle comprising (2) and (3) above is repeated 12 times.

### [Items for Confirmation and Evaluation]

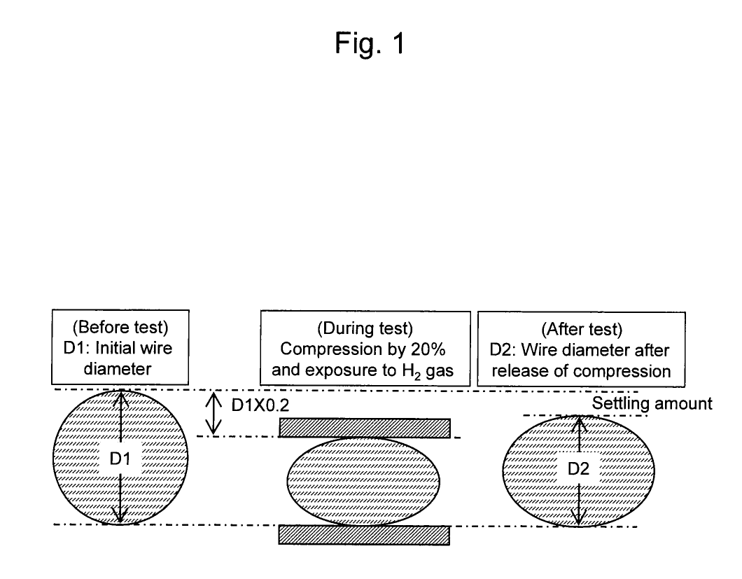

(1) Appearance evaluation in terms of expansion/foaming properties: Appearance is visually checked immediately after depressurization release. The presence or absence of blisters, cracks, breakage, or the like is confirmed.
(2) Permanent deformation property evaluation: The “permanent deformation amount” is obtained by measuring the diameter of a test piece (O ring) before and after the test (see FIG. 1). The permanent deformation amount (%) (compression set) can be obtained by the following equation.
Permanent deformation amount (%) (compression set)=(D1−D2)÷(D1×0.2)×100 (where D1 represents the initial wire diameter and D2 represents the wire diameter obtained after compression by 20%, exposure to 30-MPa hydrogen gas at 85° C. for 1 hour, rapid depressurization to atmospheric pressure in 3 minutes, and release of compression).
(3) Evaluation of tensile strength at break: A test piece (O ring) is subjected to a tensile test before and after the test in the same manner as in (1) above (basic physical properties).

### [Results for Evaluation of High-Pressure Hydrogen Properties]

For evaluation of appearance in terms of expansion/foaming properties, the test was repeated 5 times. However, blisters, cracks, and breakage were not observed in the high-hardness EPDM of the Example, the PTFE perfluoro-type specialty elastomer (explosion-proof elastomer 1) of Comparative example 1, and the PTFE/propylene specialty elastomer (explosion-proof elastomer 2) of Comparative example 2 at the 1^{st}, 6^{th}, and 12^{th} test cycles. That is, similar results were obtained in the Example and the Comparative examples upon evaluation of appearance in terms of expansion/foaming properties.

Upon evaluation of “permanent deformation properties,” the “permanent deformation amount” (mean value of the data: n=5) of each material was obtained after the 12-cycle test as follows: high-hardness EPDM of the Example: 14.8%; PTFE perfluoro-type specialty elastomer (explosion-proof elastomer 1) of Comparative example 1: 25.2%; and PTFE/propylene specialty elastomer (explosion-proof elastomer 2) of Comparative example 2: 44.8%. That is, it can be understood that the sealing material of the present invention has significantly excellent anti-permanent deformation properties.

Upon evaluation of tensile strength at break, the retention rate (mean value of the data: n=5) of tensile strength at break of each material was obtained after the 12-cycle test as follows: high-hardness EPDM of the Example: 98.5%; PTFE perfluoro-type specialty elastomer (explosion-proof elastomer 1) of Comparative example 1: 97.2%; and PTFE/propylene specialty elastomer (explosion-proof elastomer 2) of Comparative example 2: 99.6%. That is, it is understood that the tensile strength at break of the sealing material of the present invention is comparable to those of the conventional sealing materials.

### [Summary of Evaluation of High-Pressure Hydrogen Durability]

Based on the above results, it is understood that expansion/foaming properties and results of tensile strength at break of the high-hardness EPDM material serving as the Example material of the present invention are comparable to those of the explosion-proof elastomers that are prior art materials. Thus, such high-hardness EPDM material has durability against high-pressure hydrogen. Moreover, it is understood that the permanent deformation properties of the high-hardness EPDM material are better than those of the explosion-proof elastomers that are prior art materials.

### 3. Evaluation of Low-Temperature Properties

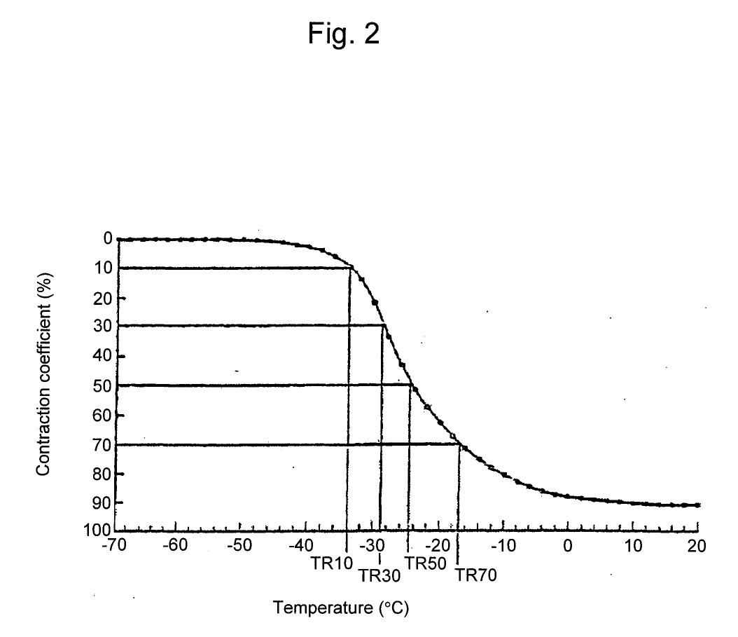

There are different performance evaluation test methods for elastomer material in low temperature environments according to JIS K 6261. Herein, an evaluation test was carried out by a method based on the low temperature elastic recovery test (TR test) selected from among the above methods. According to the low temperature elastic recovery test (TR test), a reed-shaped test piece having a thickness of approximately 2 mm is extended so as to have a predetermined length, followed by freezing at low temperatures. Then, the temperature at which elastic recovery of the test piece is induced as a result of temperature increase such that the constant contraction coefficient is obtained is measured for evaluation of low-temperature properties. FIG. 2 shows an example of contraction coefficient-temperature curve data.

Herein, for test evaluation of the Example and Comparative example materials, evaluation of low-temperature properties was carried out by the following method under the following conditions.

Initial extension rate=50%
Evaluation and judgment=TR10 temperature (temperature at which the contraction coefficient is 10%)

As a result of evaluation of low-temperature properties, it was found that the temperature was −46° C. in the case of the high-hardness EPDM of the Example. In the case of the PTFE perfluoro-type specialty elastomer (explosion-proof elastomer 1) of Comparative example 1, the material was found to be in an ebonite form, and thus it was impossible to carry out measurement. In the case of the PTFE/propylene specialty elastomer (explosion-proof elastomer 2) of Comparative example 2, the temperature was 4° C. That is, it is understood that elastic recovery of the sealing material of the present invention can be observed at extremely low temperatures.

### [Summary of Evaluation of Low-Temperature Properties]

Based on the above results, it is understood that the high-hardness EPDM material of the Example material of the present invention is obviously superior to the explosion-proof elastomers that are prior art materials. Specifically, upon comparison with the explosion-proof elastomer 2, low-temperature properties were found to be effectively improved, resulting in a decrease by slightly over 40° C. In addition, in the case of the explosion-proof elastomer 1, the material was in an ebonite form that significantly differs from an elastomer form, and thus it was impossible to test and evaluate in terms of low-temperature properties.

### INDUSTRIAL APPLICABILITY

The high-pressure hydrogen container of the present invention is excellent in duration performance in variable pressure environments, and it is also excellent in “anti-permanent deformation properties” in high-temperature and low-temperature environments. In particular, such high-pressure hydrogen container is a highly suitable high-pressure hydrogen container for fuel-cell vehicles. The high-pressure hydrogen container of the present invention contributes to practical and widespread use of fuel-cell vehicles.

1. A high-pressure hydrogen container that is filled with hydrogen at high pressures, in which at least one elastomer is used as a sealing material, such elastomer having a hydrogen gas permeability coefficient or helium gas permeability coefficient of 5.0×10⁻¹⁰ to 5.0×10⁻⁹ cm³ (STP)·cm/cm²·sec·cmHg.

2. The high-pressure hydrogen container according to claim 1, wherein the hardness of the elastomer is from 75 IRHD to 95 IRHD, such hardness being obtained by a micro hardness test according to JIS K6253 with the use of an O ring specified in JIS B2401 G25.

3. The high-pressure hydrogen container according to claim 1, wherein the TR10 of the elastomer, which is measured by a low-temperature elastic recovery test according to JIS K6261, is −30° C. or less.

4. The high-pressure hydrogen container according to claim 1, wherein the “permanent deformation amount (compression set)” of the elastomer represented by the following equation is 20% or less:
permanent deformation amount (%) (compression set)=(D1−D2)÷(D1×0.2)×100 (where D1 represents the initial wire diameter and D2 represents the wire diameter obtained after compression by 20%, exposure to 30-MPa hydrogen gas at 85° C. for 1 hour, rapid depressurization to atmospheric pressure in 3 minutes, and release of compression).

5. The high-pressure hydrogen container according to claim 1, wherein the elastomer is at least one selected from the group consisting of ethylene propylene diene monomer rubber (EPDM), ethylene propylene rubber (EPR), silicon rubber, natural rubber, isoprene rubber (IR), and nitrile isoprene rubber (NIR).

6. The high-pressure hydrogen container according to claim 1, which is a vehicular high-pressure hydrogen container for supplying hydrogen to fuel cells in a fuel-cell vehicle.
